(19) United States
(12) Patent Application Publication
(10) Pub. No.: US 2008/0133832 A1
(43) Pub. Date: Jun. 5, 2008

(54) Flash drive-radio combination

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/566,203

(22) Filed: Dec. 1, 2006

(51) Int. Cl. G06F 12/00

(52) U.S. Cl. 711/115

(57) ABSTRACT

A flash drive incorporating a FM scanner radio, of which the circuitry is electrically isolated from each other and separately powered to reduce production cost and size. The flash drive-radio combination comprises a radio and a flash drive encased in a housing. The radio is configured only to search, receive, and convert to audio signals, radio signals that lies within only the broadcast FM bands, and the flash drive comprises a flash memory, a bidirectional communication port, a controller, and preferably, a display unit for displaying used and available memory in the flash memory. A write protect switch, a channel scan button, a digital clock may be further included in the present invention.

### FIELD OF THE INVENTION

The present invention relates to field of a portable flash memory drive combined with a scanner radio.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

Portable flash memory drives are becoming increasingly popular means, over other forms of storage media, for saving electronic digital data, such as music, graphics, multimedia files, texts, or other document files due to their compactness, large storage capacity, portability, and stability and durability against data corruption or physical damage. Particularly, the USB (Universal Serial Bus) ports have become the most preferred standard in flash drives for transferring electronic data to and from a wide variety of electronic devices such as computers, MP3 players, CD players, televisions, etc., that in turn have a matching USB port for connecting the portable flash drives. One of the advantages of a flash drive using the USB port is that the USB port can derive power needed to drive the flash drive directly from the electronic device connected to the flash drive for exchanging electronic data, eliminating the need of having a separate power source connected to, or within, the flash drive. Owing to such merits of portable flash drives with USB ports, they have become nowadays almost part of essential personal belongings to carry in pockets, purses, or even neck laces or key chains.

Radios are also among the most popular consumer electronic products in everyday life. Commonly, many commercially marketed radios carry extra functions, such as recording capability or converting the sound signals to a format readable by a multimedia device like an MP3 player, in addition to their principal function, receiving radio signals and converting them to sound signals, or have built-in speakers for producing sounds. Although such radios are more fanciful due to multiple functions, they are relatively costly and usually quite bulky to carry outdoors. There are many situations, however, in which people are satisfied with the simplest function of a radio. For example, people may simply wish to listen to music or sports broadcasting from favorite radio stations, or monitor current traffic or weather conditions during walking or outdoor working. In such situations, a low-cost portable radio receiver having only a simple function of searching and receiving radio signals of frequencies within the broadcast radio bands will do the purpose. For such a radio, it may be desirable to remove speakers also and replace them with a sound outlet to which an earphone can be connected for listening sound in order to further reduce production cost and size, and not to annoy other people around.

It would be advantageous if such a low-cost portable radio receiver can be integrated with other common portable electronic devices, for example, a flash memory drive. There are many commercially available products that disclose combination of a radio, a flash drive, and mostly, an MP3 player, in which electronic sound data stored in the flash memory, either being transferred from an external device or converted from radio signals received by the radio, can be played by the MP3 player. Most of such products, however, inevitably require additional circuitry and software for converting the received radio signals into electronic data in a format playable by the MP3 player. Further, the circuitry of the radio should be electronically connected to that of flash drive to save the converted radio signals in the flash memory, and for that, additional software would be needed. Necessarily, those added features in such devices increase both the cost of production and the size of the devices to the detriment of portability. However, if a user needs no other function than simply receiving radio signals and converting them to sound signals, the function of most FM scanners, then combining such a simple radio with the common flash drive would greatly reduce the production cost and size because the required radio circuitry, which is relatively simple in such a case, can be separately formed from that of the flash drive.

One prior art reference, US Patent Application Publication No. 2005/0210168 discloses a USB flash drive and an external cap for detachably covering the USB connector, where a radio is formed in the external cap. When the cap is connected to the flash drive via the USB connector, a user can listen to the radio with an earphone connected to the flash drive. One drawback of this invention is that the external cap including the radio, being a separate piece from the flash drive, is vulnerable to the risk of loss, which happens frequently for the common flash drives having detachable caps. Further, the reference discloses that the radio circuitry in the external cap and the flash drive circuitry are electrically connected when the cap is coupled to the USB flash drive. Therefore, it is desirable to provide a device having the function of both the common flash drive and simple radio receiver, which is more economical and has a smaller size for better portability than those in the prior art.

### SUMMARY OF THE INVENTION

The present invention provides a flash drive incorporating a FM scanner radio whose circuitry is electrically disconnected from that of the flash drive to reduce production cost and size.

The flash drive-radio combination made in accordance with the present invention comprises a radio and a flash drive encased in a housing wherein the circuitry of the radio and flash drive are electrically isolated from each other, and further, powered from separate power sources. More particularly, the radio comprises a radio circuitry for searching and receiving radio signals, preferably with FM frequencies within the broadcast radio bands, and converting them to electric signals, and a radio output port to transfer the electric signals to an external device, such as an earphone, that converts the electric signals to sound. The radio, which performs basically the function of the well-known FM scanner, searches among the frequencies in the bands automatically when a scan direction is given by a user, for instance, by pressing a scan button formed on the housing, until a frequency whose signal strength is greater than a preset threshold value is found.

The flash drive comprises a nonvolatile flash memory, a bidirectional communication port such as, preferably, a USB port, and a control unit, such as a common USB controller comprising a rom, a ram, and a microprocessor, for driving the flash memory and providing an interface with the communication port.

In the preferred embodiment, the flash drive-radio combination may further comprise a display unit formed on the housing, such as a LCD, to display the information on the amount of used and available memory in the flash memory, which may be supplied from a separate memory check circuit connected to the flash memory. The radio is separately powered from the display unit and the memory check circuit, powered respectively from first and second batteries disposed in the housing. The rest of flash drive components may be powered directly from an external device, such as a personal computer, connected to the flash drive through the USB port for reading or writing the electronic data contained in the flash memory.

The USB port may comprise, preferably, the common USB connector which may be either retractable or non-retractable, coming with a protection cap. Further, a write protect switch can be provided to prevent accidental data deletion or deformation in the flash memory. The flash drive may be compatible with both an IBM®-compatible PC and a Macintosh® personal computer. Also, the flash drive may further comprise circuitry for a digital clock, which may be also powered from the second battery, wherein the time information is displayed on the display unit.

### BRIEF DESCRIPTION OF THE DRAWINGS

FIG. 1 is a perspective view of the flash drive-radio combination made in the preferred embodiment of the present invention;

FIG. 2A is a front elevational view of the flash drive-radio combination made in the preferred embodiment of the present invention;

FIG. 2B is an extended view of the display screen of the flash drive-radio combination made in the preferred embodiment of the present invention;

FIG. 3 is a bottom plan view of the flash drive-radio combination made in the preferred embodiment of the present invention;

FIG. 4 is a top plan view of the flash drive-radio combination made in the preferred embodiment of the present invention; and

FIG. 5 is a block diagram showing the circuit components in the preferred embodiment of the present invention.

### DETAILED DESCRIPTION OF THE INVENTION

The present invention generally relates to a flash drive incorporating a radio that has a simple function of searching, receiving, and converting to sound signals, radio signals only within the broadcast FM bands, such as a common FM scanner, wherein the circuitry of the flash drive and the radio are electrically separated from each other to reduce production cost and size.

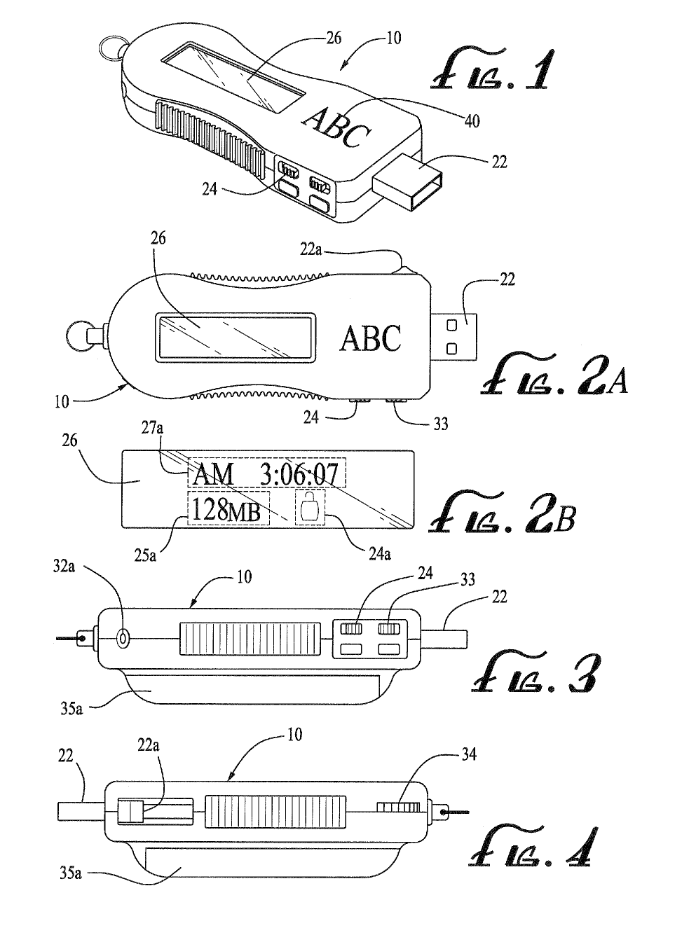

Several preferred embodiments of the present invention will now be described with reference to FIGS. 1-5, wherein like components are designated by like reference numerals throughout the figures. Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

Now referring to FIG. 1, the flash drive-radio combination comprises, in the preferred embodiment, a housing 10, preferably, in a shape of an elongated rectangular box, a substrate for disposing thereon the circuitry of a flash drive 20 and a radio 30, which is sized and configured to be fitted in the housing 10. The housing 10 may be fabricated of plastic, metal, or any other adequate material known to those skilled in the art. The substrate forms, preferably, a printed circuit board (PCB) on which surface-mounted integrated circuits (IC) for the flash drive 20 and the radio 30 are mounted. The technical details manufacturing a PCB with ICs are well known in the art.

FIG. 5 shows the block diagram of the circuit components of the flash drive-radio combination in the preferred embodiment of the present invention comprising the circuitry of the flash drive 20 and the radio 30. In the present invention, the circuitry of the flash drive 20 is completely electrically isolated from the that of the radio 30, and as such, forms a separate group of IC on the PCB from the radio 30. The flash drive 20 largely comprises; at least one flash memory chip 21, a bidirectional communication port 22, and an input/output (I/O) controller 23 electrically connected to the other two. The nonvolatile flash memory chip 21 may be a NAND type typically used in a digital camera, having a capacity typically ranging from 8 megabytes to 64 gigabytes.

The bidirectional communication port 22 forms an interface with external flash devices 28 for exchanging electronic data stored in the flash memory 21. In the preferred embodiment, the bidirectional communication port is a conventional USB port 22 wherein external flash devices 28 are physically connected by a commonly used male-type USB connector 22, as shown in FIGS. 1-4. In other embodiments, however, the bidirectional communication port may use any other type of wired or a wireless interface recognized by one skilled in the art including, but not limited to, FIREWIRE (IEEE 1394), USB 1.0, USB 2.0, or BLUETOOTH.

In the preferred embodiment, the USB connector 22 is configured to be retractable into a compartment formed in the housing 10 for its protection when not in use. When a connection to the external flash devices 28 is needed, it can be slidingly pushed out of the housing 10 via, for example, a switch 22a formed on the housing 10 as shown in FIGS. 2A and 4. However, in another embodiment, the USB connector 22 may be made as non-retractable, in which case, for its protection against physical damage or damage from static electricity, a protection cap or cover, either detachable from or permanently attached to the flash drive, may be used.

The I/O controller 23 drives the flash memory 21, i.e., controls the transfer of the electronic data stored in the flash memory 21, and provides a linear interface, via the USB port 22, with the external serial flash devices 28, which include, but are not limited to, a desktop, laptop computers, a palm device, a printer, a digital camera, a scanner, an MP3 player. The arrows at the end of lines inter-connecting the flash memory 21, the I/O controller 23, the USB port 22, and the external flash devices 28 in FIG. 5 represent the direction of signal flows, or the transfer of electronic data, and as is seen therefrom, the transfer of electronic data is bidirectional. In the preferred embodiment, the I/O controller 23 may be a well known USB controller 23 comprising, typically, a small RISC microprocessor and a small amount of on-chip read-only-memory (ROM) and random-access-memory (RAM). To prevent accidental deletion of the electronic data stored in the flash memory 21, the flash drive 20 may further comprise a write-protection switch 24 electrically connected to the USB controller 23, and formed on the housing 10 as shown in FIGS. 1, 2A, and 3.

Referring again to FIG. 5, in the preferred embodiment, the flash drive 20 may further include a memory-check circuitry 25 electrically connected to the circuitry of flash memory 21, and if needed, to the I/O controller as well to check the available and/or used memory in the flash memory 21 and generate digital signals for such memory information 25a. Moreover, the flash drive 20 may further integrate, into the circuitry thereof, a digital clock 27 to generate the time information 27a. The flash drive 20 may further comprise a display screen 26 disposed on the housing 10, which may be a liquid crystal display (LCD), a plasma screen or the like. As shown in FIG. 2B, the display screen 26 may display thereon the memory information 25a, the time information 27a, and preferably, also the information 24a on whether the write-protection switch 24 is activated. The circuitry needed for those various displaying methods is also well known in the art. The flash drive 20 may further have a light-emitting diode (LED) to indicate the transfer, reads, and writes of the electronic data, wherein the light emitted by the LED may be viewed form a LED opening (not shown) formed on the housing 10.

In the preferred embodiment, the I/O controller 23 of the flash drive 20 is BUS powered, meaning that the power needed to operate the flash drive comes, through the USB port 22, from the power source driving the external flash device 28 connected to the USB port 22 as represented by the solid line drawn therebetween next to the signal flow line. The circuitry used for implementing such an end is well known in the art. But in another embodiment (not shown), the flash drive 20 may be powered from a separate power source disposed in the housing, such as a battery or a solar cell. The memory-check circuit 25, the display screen 26, and the digital clock 27 are, preferably, powered from a first battery 29 disposed in the housing 10 so that even when the flash drive 20 is not connected to an external device, and thus not BUS powered, the memory information 25a may continue to be displayed on the display screen 26. But, for saving battery power, the memory-check circuit 25 may be configured such that it becomes activated to check and display the memory information 25a only when, for example, a memory-check button (not shown) formed on the housing is pressed.

Other essential or additional components commonly used in a conventional flash drive, including but not limited to, a crystal oscillator used for producing the device's clock signal and controlling the device's data through a phase-locked loop, or jumpers and test pins for testing the flash drive during manufacturing, may be also included in the flash drive 20. The circuitry used for those is well known in the art, and thus, not described herein further.

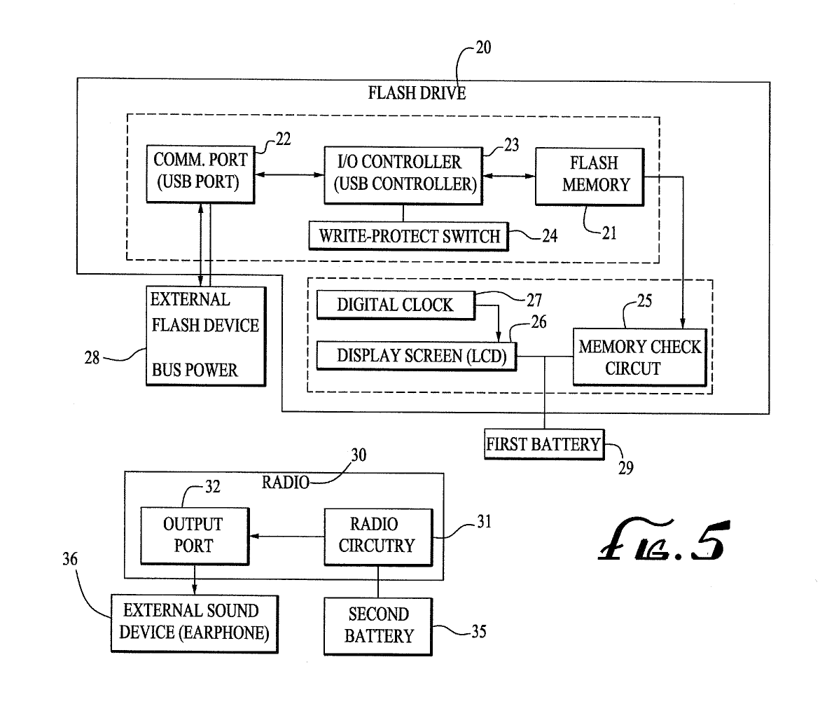

Referring again to FIG. 5, in the present invention the radio 30 comprises radio circuitry 31 and a radio output port 32. The radio circuitry 31 has only a simple function of: searching for and receiving radio signals of frequencies within the broadcast radio bands, preferably FM bands; generating digital audio signals therefrom; and transferring the audio signals to a radio output port 32. The radio output port 32 is connected to a jack opening 32a formed on the housing 10 as shown in FIG. 3, to which external sound devices 36 generating sound from the audio signals, such as speakers, earphones, or headphones, may be connected.

In the preferred embodiment, the radio circuitry 31 starts to search or scan, at a user's command, FM frequencies within the broadcast bands, starting from a last saved frequency and moving toward higher frequency until it reaches a frequency whose signal strength is above a predetermined value. Then, the circuitry 31 stops scanning and starts to receive radio signals. The scanning function may be activated by pressing a scan button 33 formed on the housing 10 as shown in FIGS. 1 and 3 in the preferred embodiment, or in another embodiment, by physically connecting an external sound device 36 to the radio output port 32.

Essentially, such simple function of radio in the present invention is that of a typical FM scanner, of which the circuitry is well known in the art. As such, in the present invention, there is no need of circuitry for converting the received radio signals into audio signals and saving them in the flash memory, or transmitting wirelessly the electronic data stored in the flash memory via radio signals to external wireless devices in contrast with many commercially available flash drives having an MP3 player. Accordingly, there is no need to electrically connect the circuitry of the FM scanner to that of the flash drive, and employ additional software for performing those extra functions mentioned above. The simple radio circuitry 31 may be formed as a separate IC on the PCB 10, completely isolated from any component of the flash drive 20, namely, the flash memory 21, the USB port 22, the USB controller 23, the memory-check circuit 25, the display screen 26, or the digital clock 27. The immediate and obvious advantage of the present invention from such combination of simplified functions is considerable reduction in manufacturing cost and size of the product.

The power to radio circuitry 31 may be supplied from a second battery 35 which may be a conventional AA battery, button cell batteries, or a solar cell. FIGS. 3 and 4 show a battery compartment 35a for containing the second battery 35, formed on the housing 10, preferably on a side opposite the side where the display screen 26 is. Another battery compartment (not shown) for containing the first battery may be formed under the battery compartment 35a as in the preferred embodiment, or on the housing 10. An on/off switch 34 as well may be formed on the housing 10 as shown in FIG. 4 for turning on and off the radio 30 and adjusting the volume.

Furthermore, the present invention may be used as a vehicle for advertising. FIGS. 1 and 2A show advertising indicia 40 imprinted on an outer surface of the housing 10, preferably on the front side where the display screen 26 lies. But such advertising indicia may be placed on any other surface of the housing 10.

The present invention is capable of embodiments other than those described above, and its several details are capable of modifications in various respects apparent to those of ordinary skill in the art, all without departing from the essential spirit or attributes of the invention. Therefore, the embodiments described hereinbefore should be considered to be merely illustrative, not restrictive.

What is claimed is:

1. A flash drive-radio combination for being heard through an external sound device and for exchanging data with an external electronic device, the flash drive-radio comprising:
a portable housing;
a radio encased in the housing, the radio comprising:
a radio circuitry configured to search for radio signals, to receive radio signals, and to convert radio signals to electrical signals, and
a radio output port electrically connected to the radio circuitry and configured to transfer the electric signals to the external sound device connectable thereto; and
a flash drive encased in the housing, the flash drive comprising:
a flash memory configured to store electronic data therein,
a bi-directional communication port configured to exchange data with the external electronic device connectable thereto, and
a control unit electrically connected to the flash memory and the communication port for reading data from and writing data to the flash memory,
wherein the radio and the flash drive are electrically isolated from each other and powered from separate sources.

2. The flash drive-radio combination of claim 1, further comprising a first power source removably disposed within the housing and electrically connected to the radio circuitry for providing power thereto.

3. The flash drive-radio combination of claim 2, wherein the radio is powered only when the external sound device is connected the radio output port.

4. The flash drive-radio combination of claim 2, wherein the control unit is powered by the external electronic device when it is connected to the communication port.

5. The flash drive-radio combination of claim 2, wherein the flash drive further comprises a memory check circuit electrically connected to the flash memory for providing memory status, and the flash drive-radio combination further comprises a display unit for displaying the memory status thereon.

6. The flash drive-radio combination of claim 5, wherein the flash drive further comprises a digital clock electrically connected to the display unit for displaying time thereon.

7. The flash drive-radio combination of claim 6, wherein the display unit is an LCD formed on an outer surface of the housing.

8. The flash drive-radio combination of claim 6, wherein the flash drive further comprises a second power source disposed removably disposed within the housing and electrically connected to the memory check circuit, the digital clock, and the display unit for providing power thereto.

9. The flash drive-radio combination of claim 1, wherein the control unit includes a flash RAM chip and a microprocessor electrically connected to each other.

10. The flash drive-radio combination of claim 1, wherein the communication port is a Universal Serial Bus (USB) port.

11. The flash drive-radio combination of claim 10, wherein the port is slideably retractable from the housing.

12. The flash drive-radio combination of claim 10, wherein the USB port comprises a non-retractable USB connector and a cover extendable thereover for protection thereof.

13. The flash drive-radio combination of claim 1, further comprising a write protect switch formed on an outer surface of the housing and electrically connected to the control unit for preventing accidental deletion of the electronic data stored in the flash memory.

14. The flash drive-radio combination of claim 1, wherein the flash drive is configured to be compatible with both an IBM®-compatible personal computer and a Macintosh® personal computer.

15. The flash drive-radio combination of claim 1, wherein the radio circuitry is configured to receive only FM radio signals of frequencies in broadcast radio bands.

16. The flash drive-radio combination of claim 15, wherein the radio circuitry is configured such that upon receiving a scan command, the radio circuitry scans radio frequencies and outputs radio signals having a signal strength above a predetermined value.

17. The flash drive-radio combination of claim 16, further comprising a scan button formed on an outer surface of the housing and connected to the radio circuitry for sending the scan command to the radio circuitry.

18. The flash drive-radio combination of claim 17, wherein the scan command is sent to the radio circuitry upon connecting the external sound device to the radio output port.

19. The flash drive-radio combination of claim 1 further comprising advertising material imprinted on an outer surface of the housing.

20. A method of advertising comprising the steps of:
(a) providing a flash drive-radio combination for being heard through an external sound device and for exchanging data with an external electronic device, the flash drive-radio comprising:
a portable housing,
a radio encased in the housing, the radio comprising:
a radio circuitry configured to search for radio signals, to receive radio signals, and to convert radio signals to electrical signals, and
a radio output port electrically connected to the radio circuitry and configured to transfer the electric signals to the external sound device connectable thereto, and
a flash drive encased in the housing, the flash drive comprising:
a flash memory configured to store electronic data therein,
a bi-directional communication port configured to exchange data with the external electronic device connectable thereto, and
a control unit electrically connected to the flash memory and the communication port for reading data from and writing data to the flash memory,
wherein the radio and the flash drive are electrically isolated from each other and powered from separate sources; and
(b) disposing advertising material on a visible outer surface of the flashdrive-radio combination.
